(19) United States
(12) Patent Application Publication
(10) Pub. No.: US 2004/0090687 A1
(43) Pub. Date: May 13, 2004

(54) Three-way eye mirror

(76) Inventor: Schooler Samukawa, Sweetwater, TX (US)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(21) Appl. No.: 10/290,784

(22) Filed: Nov. 12, 2002

(51) Int. Cl. G02B 5/08

(52) U.S. Cl. 359/850; 359/838

(57) ABSTRACT

The invention is to improve ones view of their eyes for the express purpose of ministering to the eyes. The angle of reflection from the three angled magnified mirrors give the viewer a closer and clearer view of either the upper or lower lid. The open container design allows the viewer easy access to viewing their eyes and application of anything to the eyes or eye area. The magnification improves the view of the observer simultaneously from three different vertical angles for the purpose of clearly seeing the upper or lower lid of the eye.

### CROSS-REFERENCE TO RELATED APPLICATIONS

U.S. Patent Documents

U.S. Pat. No. 2,309,544 January 1943: Scharff 350/305

U.S. Pat. No. D192,375 March 1962: Laughlin D44-15

U.S. Pat. No. 3,620,305 November 1971: Clark 350/305

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The use of a magnification mirror relates to the increased use of eye cosmetics and medication and in particular to eye examination devices. The use of reflecting with offset or spaced apart optical devices facilitates the viewer in seeing their eyes.

With the increased use of contact lenses for vision or cosmetic purposes the viewer can easily inspect and tend their eyes. As the population ages where their use of eyesight aids precludes their use of non-magnified optical devices.

Magnified or unmagnified mirrors with only one viewing angle offer the viewer an inadequate view of their eyes. Compact mirrors with the one viewing angle generally do not address the viewing of the upper and lower lids. The three angled mirrors offer the optimum view to the viewer. These mirrors are positioned at such angles as to give the user a close and different angle of perception of their eyes to facilitate application of make-up, medication, insertion of contact lenses or grooming.

### BRIEF SUMMARY OF THE INVENTION

The invention of a three-way magnifying mirror that allows the viewer to see their eyes from three angles by only moving the eyes and without having to turn the head will facilitate people in applying eye make-up, installing contact lenses or any other ministration to the eyes.

Magnifying mirrors before were flat surfaces and did not allow for viewing all three angles at one glance. With the angles of the three mirrors in this invention one can easily see the top lids of their eyes for applying any cosmetics. The angles also facilitate the viewer in seeing that their contact lenses are correctly installed and positioned. Any application of medication will be father assisted by view of the eyes from three angles.

The object of this mirror arrangement using magnifying mirrors to allow a viewer with weakness' in vision the same ease in ministering to their eyes whatever their need be and those with good vision a magnified view of their eyes.

### DESCRIPTION OF THE SEVERAL VIEWS OF THE DRAWINGS

FIG. 1 is a front perspective of an eye mirror showing my design;

FIG. 2 is a rear elevation thereof;

FIG. 3 is a top plan view thereof;

FIG. 4 is a side view thereof;

FIG. 5 is an illustration of the mirror arrangement when looking into the device and showing the images seen by the observer.

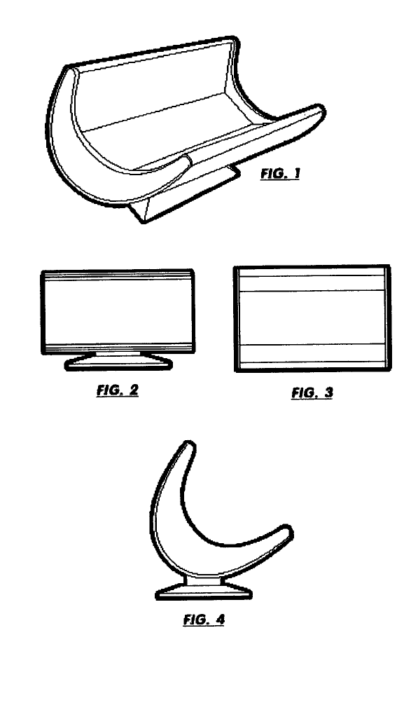

### DETAILED DESCRIPTION OF THE INVENTION

This invention is an arrangement of three magnifying mirrors for administrating to ones eyes, whether for installation of contact lenses, the application of medication to the eyes, the application of cosmetics to the eyes or grooming purposes.

The mirrors are in fixed positions, set at angles suitable for seeing ones eyes at three different angles.

The use of this invention is for the viewer to be able to see their eyes easily with only an easy movement of their eyes. The upper lid of the eye can be effortlessly seen by looking down into the lower mirror, while looking up into the upper mirror will give the viewer a complete view of the lower lids and looking directly into the center mirror will give the viewer a magnified view of their eyes. The ease with which these can be viewed will aid the viewer in grooming the eye area and/or applying medication, contact lenses or make-up to ones eyes. Flat surfaced mirrors do not allow the viewer this ease or complete view of the viewer's eyes.

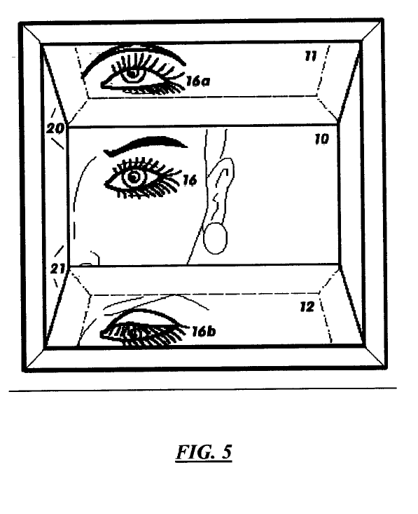

With reference to FIG. 5, the invention comprises a first or central magnifying mirror or reflecting surface 10 facing the viewer, an upper magnifying mirror or reflecting surface 11 placed along the upper edge of the first magnified mirror 10 with its reflecting surface facing down and a lower magnifying mirror or reflecting surface 12 placed along the lower edge of the first magnifying mirror 10 with its reflecting surface facing up.

The arrangement of the magnifying mirrors 11 and 12 to magnifying mirror 10 require critical angles. For the normal eye, the upper angle 20 and the lower angle 21 can range from 98 to 122 degrees. It has also been found that for the same size mirrors and mirror spacing upper and lower angles 20 and 21 can also range form 103 to 113 degrees with the best angle ranging from 106 to 110 degrees.

With reference to FIG. 5, the viewer when looking into the magnifying mirror described above, viewed from a distance of about one half of normal reading distance, will see three different views of the eye. Eye image 16 as seen in mirror 10, eye image 16a as seen in mirror 11, eye image 16b as seen in mirror 12. The eye 16 of the viewer when looking down into the lower mirror 12 can see the top eyelid and when looking to the upper mirror 11 can see the lower eyelid, by merely moving the eye.

Thus is described an optical device where by a viewer can see his eye simultaneously from three different angles.

1. What I claim as my invention is a fixed arrangement of three magnifying mirrors, consisting of a central mirror upper and lower mirror, connected in such a way as to facilitate the view of the eyes of the viewer from three different angles simultaneously.
The mirrors are secured in a framework that facilitates the viewer in seeing their reflection. Said framework holds said fixed arrangement of mirrors, compromised of a central, upper, and lower mirror. The angle between the central mirror and each of the upper and lower mirrors is fixed between 98 and degrees. The approximate edges are spaced so that the viewer can see his eye in all three mirrors simultaneously.
Whereby said view of the viewer's eyes is magnified and seen from three different angles simultaneously, when looking into the mirror at approximately one-half the normal reading distance, without tuning the viewers head, and only moving the viewer's eye.
